(19) United States
(12) Patent Application Publication
(10) Pub. No.: US 2011/0103730 A1
(43) Pub. Date: May 5, 2011

(54) Rolling bearing and plastic cage for rolling bearing

(76) Inventors: Yosuke Oya, Mie (JP); Kengo Hiramatsu, Mie (JP)

(21) Appl. No.: 11/795,150

(22) PCT Filed: Nov. 30, 2005
(86) PCT No.: PCT/JP2005/021994

§ 371 Date: Jul. 29, 2009

(30) Foreign Application Priority Data
Feb. 21, 2005 (JP) 2005-044000

(51) Int. Cl. F16C 19/24; F16C 33/48

(52) U.S. Cl. 384/548; 384/572

(57) ABSTRACT

Problems of an acoustic trouble and a bearing lock are solved by securing a guide clearance of a plastic cage (18) of a rolling bearing (10).

The plastic cage (18) is divided at a part in a circumferential direction to provide an opening section (20). The circumferential length of the opening section (20) is set to the sum total of an extension by temperature variation, an extension by variation in water absorption, and a circumferential length for securing the guide clearance.

### TECHNICAL FIELD

The present invention relates to a rolling bearing and a plastic cage for the rolling bearing, and in particular, to a cage of an ultra thin rolling bearing used in an industrial robot, a machine tool, medical equipment, and the like, though the present invention is not limited to them.

### BACKGROUND ART

FIG. 3 shows an example of a CT scanner apparatus being a kind of medical equipment. In the CT scanner apparatus, X-rays generated in an X-ray tube assembly 1 are applied to a subject 4 through a wedge filter 2 for evening the intensity distribution of the X-rays and a slit 3 for limiting the intensity distribution thereof. A detector 5 receives the X-rays which have passed through the subject 4 to convert them into electronic signals and send them to a computer which is not illustrated. Each component of the X-ray tube assembly 1, the wedge filter 2, the slit 3, the detector 5, and the like is attached to an approximately cylindrical rotational base 8 which is rotatably supported by a fixed base 7 through a bearing 6 so that the components rotate about the subject 4 in accordance with the rotation of the rotational base 8. Rotating the X-ray tube assembly 1 and the detector 5 opposed to each other about the subject 4 makes it possible to obtain projection data covering all angles of every point in an examination section of the subject 4, and a tomographic image is obtained from the data by using a reconfiguration program programmed in advance.

In the CT scanner apparatus, the inner peripheral surface of the fixed base 7 is formed to have a large diameter of approximately 1 m so that the subject 4 can enter. Thus, the so-called ultra thin rolling bearing the cross section of which is extremely small with respect to the diameter is used as the bearing 6 between the fixed base 7 and the rotational base 8.

FIG. 4 is a front view of a cage 22 used in the bearing 6 of the CT scanner apparatus shown in FIG. 3. The cage 22 is of a plastic and is composed of a plurality of arc-shaped segments 24 connected to each other to be formed into a ring. The segment 24, as shown in FIG. 5, is provided with an arc-shaped base section 26, pole sections 28 extending from the base section 26 into the shape of a cantilever, and a plurality of pockets 30a and 30b formed between the adjacent pole sections 28. The pole sections 28 extend in an axial direction beyond a pitch circle of a rolling element (ball) shown by a chain line in FIG. 5. The pockets 30a and 30b in the illustrated example have two kinds of shapes. Namely, there are the first pocket 30a the wall of which on a ball insertion side (upper side of FIG. 5) with respect to a pocket center (in the foregoing pitch circle in FIG. 5) takes the shape of a recessed arc surface in a plan view and the second pocket 30b the wall of which is formed into a straight surface in the axial direction. The first pockets 30a and the second pockets 30b alternately appear in the circumferential direction. In any pocket, a cross section in a radial direction (a cross section perpendicular to the plane of FIG. 5) is a recessed curved surface the center of curvature of which is the pocket center.

To insert balls into the pockets 30a and 30b, the ball is squeezed through a ball insertion section of the pockets 30a and 30b into a deeper side. At this time, it is necessary to insert the ball with spreading the pole sections 28 on the insertion side in the first pocket 30a. The second pocket 30b, however, does not need such trouble, so that it is possible to simplify a ball insertion process into the cage 22. The shape and structure of the pockets 30a and 30b described above are just examples, and pockets with various shapes and structures are available in accordance with the working condition of the bearing and the like. For example, the pockets may have a single shape.

Coupling sections for coupling the adjacent segments each other are provided at both ends of each segment 24. In this instance, coupling sections 32a and 32b are exemplified which are engaged with the coupling sections of the segments to be coupled in the circumferential direction with projections and depressions. One of the coupling sections 32a has the shape of a projection the tip of which is wide. In the case of an illustrated example, the coupling section 32a is composed of an approximately cylindrical surface section extending in a radial direction of the cage and a neck section narrower than the cylindrical surface section. The other coupling section 32b is formed into the shape of a depression with a cylindrical surface so as to fit into the foregoing projection-shaped coupling section 32a. To couple the adjacent segments 24 each other, the coupling section (for example 32a) of one segment is squeezed into the coupling section (for example 32b) of the other segment in a radial direction. Thus, the coupling sections 32a and 32b are engaged with each other, and the segments 24 are prevented from separating in the circumferential direction.

Patent Citation 1: Japanese Unexamined Patent Publication No. 2001-304266

Patent Citation 2: Japanese Unexamined Patent Publication No. 2002-81442

Patent Citation 3: Japanese Unexamined Patent Publication No. 2004-218745

### DISCLOSURE OF INVENTION

### Problem To Be Solved By The Invention

As described above, a plastic cage being composed of a plurality of segments is used for the ultra thin rolling bearing. This cage is an injection molded product and a fiber reinforced polyamide resin (PA66) is generally adopted as its material.

However, PA66 has a larger coefficient of linear expansion than steel being the material of race rings of the bearing. The variation of tolerance of PA66 expands with temperature variation and PA66 expands by absorbing water, so that the circumferential length of the cage extensively varies in the case of the large bearing. Variation in the circumferential length of the cage occupies a guide clearance with the race rings and therefore causes an acoustic trouble and a bearing lock.

An object of the present invention is to solve problems such as an acoustic trouble and a bearing lock by securing a guide clearance of a plastic cage of a rolling bearing.

### MEANS FOR SOLVING THE PROBLEM

In order to solve the problems, according to the present invention, a plastic cage does not have an integral structure but has an opening section by dividing the cage at a part in a circumferential direction. The length of the opening section in the circumferential direction is kept at an amount of variation in the circumferential length of the cage or more.

In other words, the plastic cage for the rolling bearing according to the present invention is a cage provided with the opening section by dividing one part in the circumferential direction. The circumferential length of the opening section is set to the sum total of an extension by temperature variation, an extension by variation in water absorption, and a circumferential length for securing a guide clearance.

The plastic cage for the rolling bearing may be of a segment type which is composed of a plurality of segments.

In a rolling bearing which comprises an inner race ring, an outer race ring, and a plurality of rolling elements fitted between raceways of the inner and outer race rings, a plastic cage for the rolling bearing may hold the rolling elements at regular intervals in a circumferential direction.

The ratio dW/PCD of the diameter dW of the rolling element to the pitch circle diameter PCD may be 0.03 or less.

### EFFECT OF THE INVENTION

According to the present invention, if the circumferential length of the cage varies in accordance with temperature variation or variation in water absorption, and in particular, if the cage extends in the circumferential direction, the opening section is secured. Therefore, it is possible to prevent the occurrence of an acoustic trouble and a bearing lock.

### BRIEF DESCRIPTION OF DRAWINGS

FIG. 1 is a front view of a cage showing an embodiment of the present invention;

FIG. 2 is a sectional view of a rolling bearing showing the embodiment of the present invention;

FIG. 3 is a sectional view of a CT scanner apparatus;

FIG. 4 is a front view of a cage, showing the conventional technology; and

FIG. 5 is an enlarged exploded view of a segment in the cage of FIG. 4.

### DESCRIPTION OF REFERENCE NUMBERS

10 rolling bearing
12 inner race ring
14 outer race ring
16 rolling element (ball)
18 cage

### BEST MODE FOR CARRYING OUT THE INVENTION

An embodiment of the present invention will be hereinafter described with reference to the drawings.

First, the structure of a rolling bearing 10 shown in FIG. 2 will be described. The bearing 10 is composed of an inner race ring 12, an outer race ring 14, rolling elements (balls) 16, and a cage 18. The inner race ring 12 has a raceway in its outer peripheral surface. The outer race ring 14 has a raceway in its inner peripheral surface. A plurality of rolling elements 16 is rotatably fitted between the raceways of the inner and outer race rings 12 and 14. The cage 18 lying between the inner and outer race rings 12 and 14 holds the rolling elements 16 at regular intervals in a circumferential direction. Generally, there is a seal in order to seal up the bearing space between the inner and outer race rings 12 and 14 and prevent the leakage of a lubricant and the entry of foreign matters from outside, but it is not illustrated in the drawing.

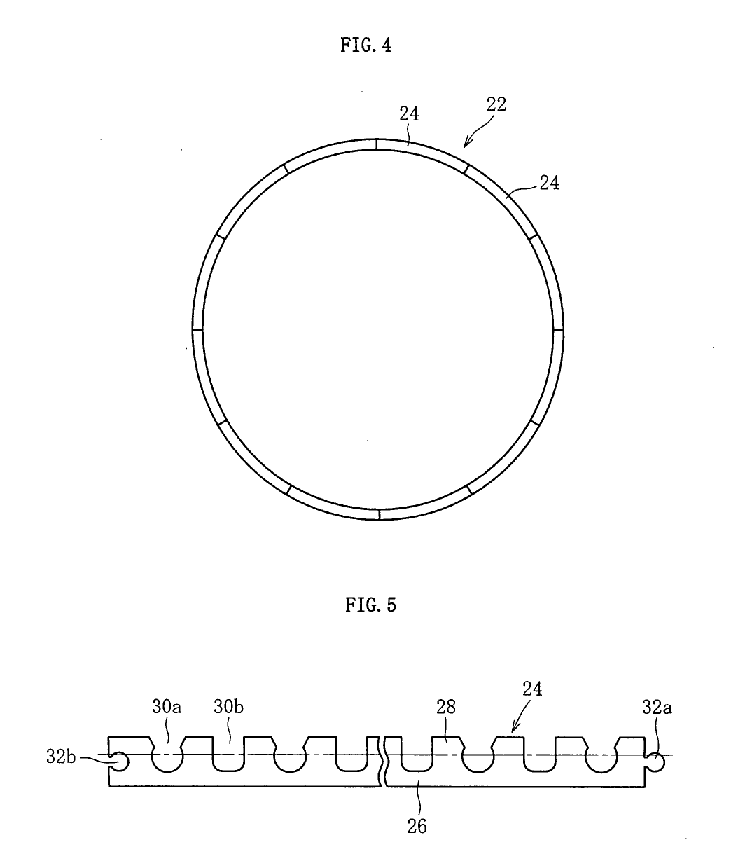

In the case of a bearing 6 for the foregoing CT scanner apparatus shown in FIG. 4, an ultra thin rolling bearing is used in which the ratio of the diameter dB of the rolling element (ball) 16 to the pitch circle diameter PCD is set to 0.03 or less (dB/PCD≦0.03). For example, when the diameter dB of the ball is ½ inch (12.7 mm) and PCD is 1041.4 mm, the ratio between them is 0.012.

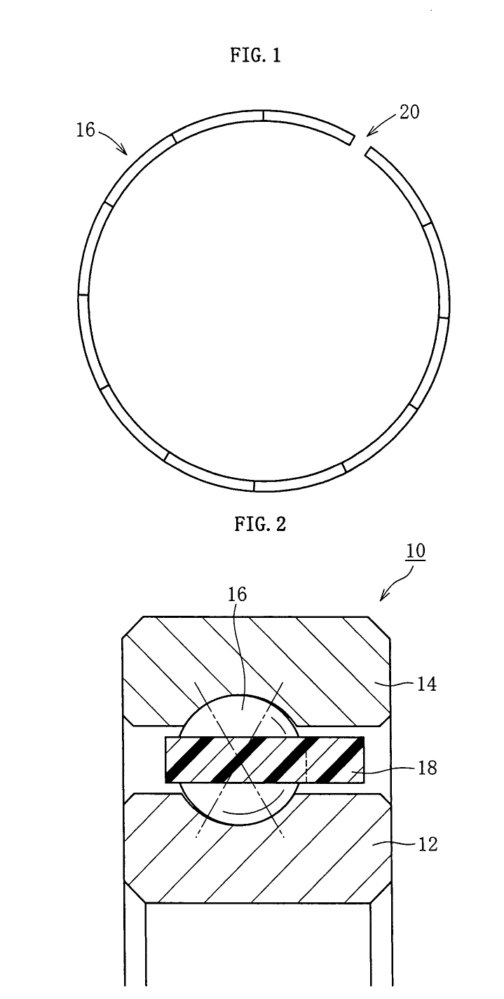

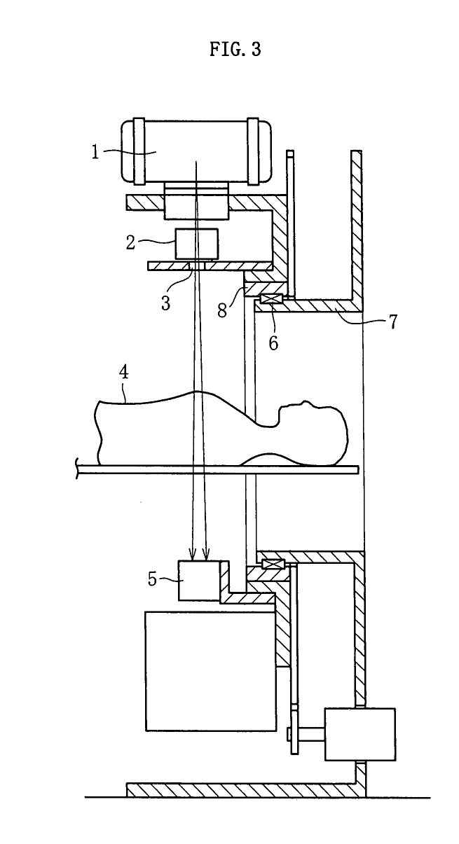

The cage 18, as shown by a reference number 20 in FIG. 1, is not a perfect annular ring but is divided at a part in the circumferential direction. This embodiment shows the case of a segment type. A coupling method between segments does not matter here. It is not always necessary to be of the segment type, but may be of another type. The cage 8 has pockets for containing the rolling elements 6 (illustration is omitted).

Taking a case in which the PCD is φ1000 mm and the guide clearance between the inner race ring 12 and the cage 18 is 1 mm as an example, a calculation example will be described. The material of the inner race ring 12 is bearing steel, and the material of the cage 18 is PA66. As representative properties, the coefficient of linear expansion of steel is 1.2×10⁻⁵, the coefficient of linear expansion of PA66 is 8×10⁻⁵, and the amount of dimensional variation of PA66 when the coefficient of water absorption varies 1% is 0.13%. It is assumed that the atmosphere temperature varies from 20 to 60 degrees centigrade and the coefficient of water absorption varies from 1.5% to 2.5%.

First, the circumferential length L(mm) of the cage 18 is obtained by the following equation:

L=PCD×π=1000×3.14159=3142.

The amount ^{δ}t(mm) of extension of the cage 18 due to the effect of temperature variation, in other words, thermal expansion is obtained by the following equation with considering difference in linear expansion to the inner ring 12:

^{δ}t=(8−1.2)×10−5×3142×40=8.55.

The amount ^{δ}w(mm) of extension of the cage 18 by the effect of variation in water absorption, in other words, expansion by water absorption is obtained by the following equation:

^{δ}w=0.0013×3142×1=4.08.

The increment ^{δ}c(mm) of the circumferential length of the cage by the effect of the guide clearance, in other words, required for forming the guide clearance of 1 mm is obtained by the following equation:

^{δ}c=1×n=3.14.

Accordingly, the amount ^{Δ} (mm) of dimensional variation in the cage is obtained by the following equation:

^{Δ}=^{δ}t+^{δ}w+^{δ}=15.77.

Therefore, in the case of this example, it turns out that the circumferential length of the opening section (20) should be set to 15.77 mm or more.

The present invention is not limited to the embodiment described above, but of course, can be modified in various ways without departing from the gist of the present invention.

1. A plastic cage for a rolling bearing, provided with an opening section by dividing one part in a circumferential direction, wherein a circumferential length of the opening section is set to a sum total of an extension by temperature variation, an extension by variation in water absorption, and a circumferential length for securing a guide clearance.

2. A plastic cage for a rolling bearing according to claim 1, comprising a plurality of segments.

3. A rolling bearing comprising an inner race ring, an outer race ring, and a plurality of rolling elements fitted between raceways of the inner and outer race rings, wherein a plastic cage according to claim 1 holds the rolling elements at regular intervals in a circumferential direction.

4. A rolling bearing according to claim 3, wherein a ration dW/PCD of a diameter dW of the rolling element to a pitch circle diameter PCD is 0.03 or less.

5. A rolling bearing comprising an inner race ring, an outer race ring, and a plurality of rolling elements fitted between raceways of the inner and outer race rings, wherein a plastic cage according to claim 2 holds the rolling elements at regular intervals in a circumferential direction.
